(19) United States
(12) Patent Application Publication
(10) Pub. No.: US 2002/0047454 A1
(43) Pub. Date: Apr. 25, 2002

(54) Stator winding for an electrical machine

(76) Inventor: Reinhard Joho, Rombach (CH)

Correspondence Address: BURNS DOANE SWECKER & MATHIS L L P, POST OFFICE BOX 1404, ALEXANDRIA, VA, 22313-1404, US

(21) Appl. No.: 09/899,160

(22) Filed: Jul. 6, 2001

(30) Foreign Application Priority Data
Jul. 6, 2000 (DE) 100 33 014.2

(51) Int. Cl. H02K 3/04; H02K 17/00; H02K 19/00

(52) U.S. Cl. 310/210

(57) ABSTRACT

In a stator winding for an electrical machine, where in said stator winding, in the winding slots (11) of a stator core (10), two each conductor bars (15, 17) are arranged between the slot base (21) and boring (22) of the stator core (10) on top of each other, whereby each of the conductor bars (15, 17) comprises a plurality of juxtaposed strand columns (15a, . . . , d or 17a, b) or strand planes, eddy current losses are effectively reduced, while limiting additional winding costs, in that the conductor bar (15) close to the boring is provided with more strand columns (15a, . . . , d) or strand planes than the conductor bar (17) close to the slot base.

This application claims priority under 35 U.S.C. §§119 and/or 365 to Appln. No. 100 33 014.2 filed in Germany on Jul. 6, 2000, the entire content of which is hereby incorporated by reference.

### FIELD OF THE INVENTION

The present invention relates to the field of electrical machines. It concerns a stator winding according to the preamble of Claim 1.

Such a stator winding is known, for example, from H. Sequenz: “Herstellung der Wicklung elektrischer Maschinen,” p. 159, Springer-Verlag, 1973.

### BACKGROUND OF THE INVENTION

It is known that in the stator winding of a high-power electrical machine the Roebel bars of a two-layer winding (with two superimposed conductor bars per slot) are constructed as twin Roebel bars with four juxtaposed strand columns or strand planes. This has been done for decades, particularly for water-cooled windings. In this way, the number of conductor bars can be halved and, therefore, the winding costs can be reduced. The strands approximately retain the same width as in a stator with a single Roebel bar. The winding slots therefore are not quite double as wide, since parts of the main insulation are eliminated.

In indirectly cooled windings with the gaseous coolant air or hydrogen, the current losses of the conductors are lost through the bar insulation. In this case, the bar design as a twin Roebel bar has only been constructed in this manner for a few years (see e.g. EP-A2-0 905 859). The reasons for this are the additional eddy current losses in the conductor, which strongly rise with increasing machine performance. This affects primarily the top strands of the conductor bar located on the top in the winding groove. Because of the disadvantageous losses, these strands greatly heat up and limit the achievable machine performance because of the temperature limits of the insulating materials. A halving of the strand width by changing from a single Roebel bar to a twin Roebel bar or 4-plane Roebel bar results in a great reduction of these eddy current losses (up to a factor of 4). As a secondary effect the twin Roebel bar also makes it possible to reduce additional losses in the winding head which here, although in a reduced form, occur to a greater degree in the conductor bar close to the boring.

The disadvantage is, however, that in indirectly cooled windings with global introduction of the twin Roebel bar, the costs for the winding increase greatly since the number of conductor bars remains the same as in the solution with the single Roebel bars.

### SUMMARY OF THE INVENTION

It is therefore the objective of the present invention to create a stator winding that resolves the problem of eddy current losses in the area of the conductor bars close to the boring while reducing the amount of extra costs.

The objective is realized with the totality of characteristics in Claim 1. The core of the invention consists of a further division of the strands, only in the conductor bar close to the boring, that reduces the eddy current losses, while the conductor bar close to the slot base that is not affected as much by the eddy current losses is divided less often. In this way, the number of strands is increased only where this is necessary, in this way controlling the additional costs for the winding.

A preferred embodiment of the invention is characterized in that the conductor bar close to the slot base is constructed as a single Roebel bar with two strands columns or partial conductor planes. This makes it possible to use proven methods of conductor bar construction within the context of the present invention.

The building, manufacturing and installation of the conductor bars becomes especially easy if the effective total width of the strand columns in both conductor bars is approximately the same, and if the effective heights of the strand columns of the two conductor bars is the same.

Further embodiments are found in the dependent claims.

### BRIEF DESCRIPTION OF THE INVENTION

Preferred embodiments of the invention are described below with reference to the accompanying drawings, wherein:

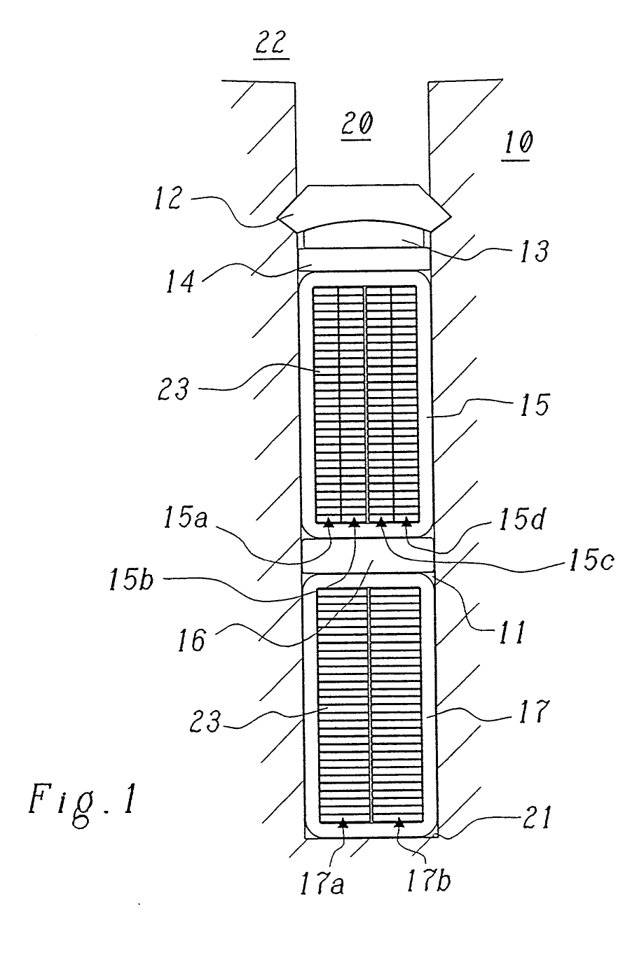

FIG. 1 is a cross-sectional view through a stator winding (limited to an excerpt of one winding groove) according to a preferred embodiment of the invention;

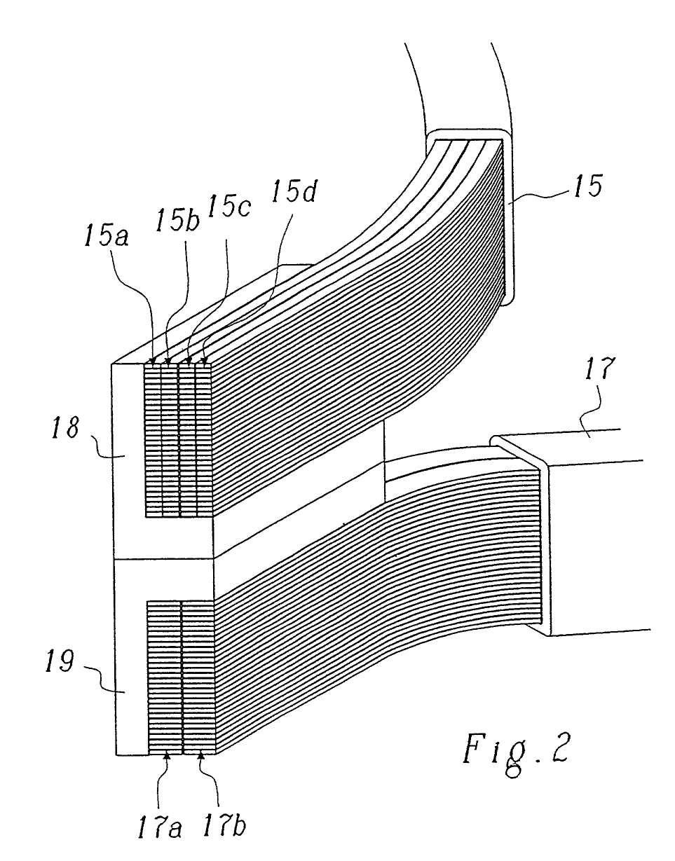

FIG. 2 is a perspective view of the winding according to FIG. 1; and

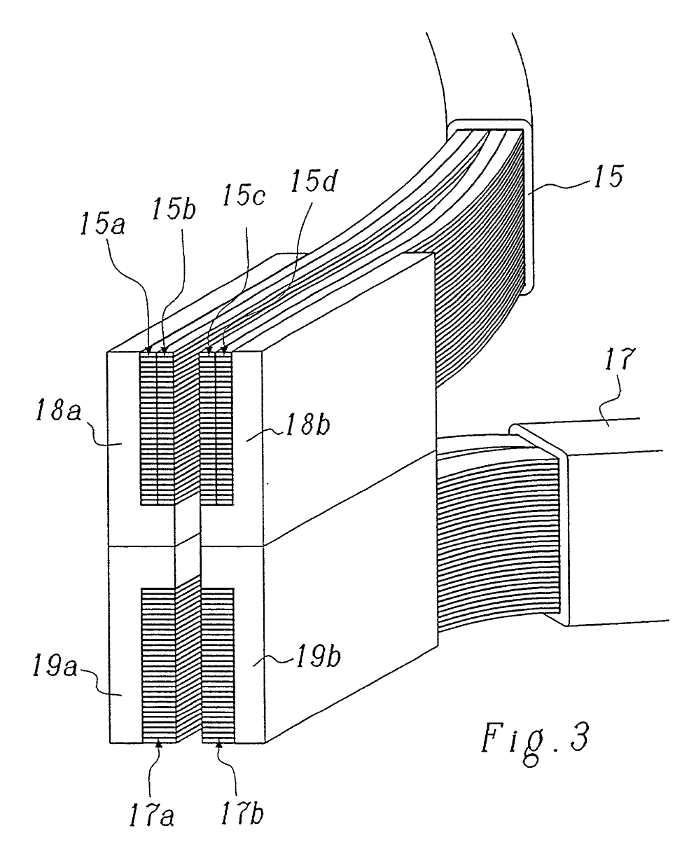

FIG. 3 is a perspective view of a modified form of the winding according to FIG. 1.

### DETAILED DESCRIPTION OF THE INVENTION

FIG. 1 shows a cross-section through a stator winding (limited to an excerpt of one winding slot) according to a preferred embodiment of the invention. The stator winding is held in a stator core 10 and is composed of individual conductor bars 15, 17, each of which is held in a winding slot 11. The winding slot 11 is open towards the central boring 22 of the stator core 10 and is limited on the opposing side by a slot base 21. In the winding slot 11, two conductor bars 17 and 15 are arranged on top of each other. Accordingly, the conductor bar 17 is the conductor bar close to the slot base, while the conductor bar 15 is the conductor bar close to the boring. The conductor bars 15, 17 are constructed of a plurality of individual strands 23 or, respectively, 23′, which are stacked on top of each other to create several juxtaposed strand columns 15a, . . . , d or 17a, b respectively. When transposing the strands 23, 23′ in the framework of a Roebel arrangement or other manner, the strand columns at the same time form strand planes. The insulation of the conductor bars 15, 17 takes place with known methods which are not further discussed here.

The two conductor bars 15 and 17 are separated from each other by a filler 16. They are held in the winding slot 11 by a slot closure arrangement that comprises, as known per se, a slot wedge 12, a lower wedge part 13, and a wedge base layer 14. The height of the slot head 20 remaining above the slot wedge 12 is determined by requirements that in part contradict each other, such as compactness, reactance levels, and additional bar losses.

The conductor bar 15 close to the boring in the shown example comprises four strand columns or planes 15a, . . . , d; however, the conductor bar 17 close to the slot base only comprises two strand columns or planes (17a, b). The strands 23 of the conductor bar 15 close to the boring approximately are half as wide as the strands 23′ of the conductor bar 17 close to the slot base, so that approximately the same (electrically) effective total width is obtained for the two conductor bars (15, 17). It is also preferred that the effective heights of the two conductor bars 15 and 17 are identical. But if more value is placed on a compensation of the bar losses and less value on the limitation of the additional winding costs, the effective height of the conductor bar 15 close to the boring can be increased, which has a negative effect on the conductor bar 17 close to the slot base. In addition, the thickness of the strands in the conductor bar 17 close to the slot base can be chosen larger.

The doubling of the number of strands 23 only in the conductor bar 15 reduces the additional costs for the bar by half when compared to a doubling in both bars. The strand columns 15a, . . . d in the conductor bar 15 close to the boring may be combined, for example, as a twin Roebel bar, whereby the strands 23 of two adjoining strand columns 15a, b and 15c, d in each case are transposed with each other. It would also be conceivable, however, to transpose the strands 23 of all strand columns 15a, . . . , d among each other within a 4-plane Roebel bar. The strands 23′ of the strand columns 17a, b of the conductor bar 17 close to the slot base preferably are transposed with each other in the form of a single Roebel bar.

The connection of the 4-plane conductor bar 15 close to the boring with the corresponding conductor bar 17 close to the slot base that is constructed as a single Roebel bar at the bar end may be accomplished in two ways according to FIGS. 2 and 3:

If the strands 23 of all strand columns 15a, . . . d of the conductor bar 15 close to the boring are transposed with each other, as is the case for example in compensating twin Roebel bars, e.g. in the form of so-called “braided bars”, all strand columns 15a, . . . , d and 17a, b can be connected with each other according to FIG. 2 in a massive connection using two eyes 18,19 at the bar ends.

But it would also be possible, according to FIG. 3, to make a divided (split) connection using two pairs of eyes 18a, 19a and 18b, 19b, whereby two each strand columns 15a, b or 15c, d of the conductor bar 15 close to the boring are connected with the corresponding strand column 17a or 17b, respectively, of the conductor bar 17 close to the slot base.

What is claimed is:

1. Stator winding for an electrical machine, where in said stator winding, in the winding slots (11) of a stator core (10), two each conductor bars (15, 17) are arranged between the slot base (21) and boring (22) of the stator core (10) on top of each other, whereby each of the conductor bars (15, 17) comprises a plurality of juxtaposed strand columns (15a, . . . , d or 17a, b) or strand planes, characterized in that the conductor bar (15) close to the boring is provided with more strand columns (15a, . . . , d) or strand planes than the conductor bar (17) close to the slot base.

2. Stator winding as claimed in claim 1, characterized in that the conductor bar (17) close to the slot base is constructed as a single Roebel bar with two strand columns (17a, b) or strand planes, and that the conductor bar (15) close to the boring is provided with three or more strand columns (15a, . . . , d).

3. Stator winding as claimed in claim 2, characterized in that the conductor bar (15) close to the boring is constructed as a twin Roebel bar with four strand columns (15a, . . . , d) or strand planes.

4. Stator winding as claimed in one of claims 1 to 3, characterized in that the effective total width of the strand columns (15a, . . . , d or 17a, b) in both conductor bars (15, 17) is approximately the same.

5. Stator winding as claimed in claim 4, characterized in that the effective height of the strand columns (15a, . . . , d) of the conductor bar (15) close to the boring is at least as high as the effective height of the strand columns (17a, b) of the conductor bars (17) close to the slot base.

6. Stator winding as claimed in claim 5, characterized in that the effective heights of the strand columns (15a, . . . , d or 17a, b) of the two conductor bars (15, 17) are the same.

7. Stator winding as claimed in one of claims 1 to 6, characterized in that corresponding conductor bars (15, 17) are connected at the bar ends, and that the eye (18, 19) is made for all strand columns (15a, . . . , d; 17a, b) together.

8. Stator winding as claimed in claim 3, characterized in that the corresponding conductor bars (15, 17) are connected at the bar ends, and that the eye (18a, 19a; 18b, 19b) is made separately for corresponding strand columns (15a, b; 17a or 15c, d; 17b) of the two conductor bars (15, 17).
